(19) United States
(12) Patent Application Publication
(10) Pub. No.: US 2014/0149617 A1
(43) Pub. Date: May 29, 2014

(54) I2C BUS STRUCTURE AND DEVICE AVAILABILITY QUERY METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: REN-HONG CHIANG, New Taipei (TW); DUN-HONG CHENG, Shenzhen (CN); KE-FENG YOU, Shenzhen (CN)

(21) Appl. No.: 13/942,213

(22) Filed: Jul. 15, 2013

(30) Foreign Application Priority Data
Nov. 27, 2012 (CN) 201210489544X

(51) Int. Cl. G06F 13/364

(52) U.S. Cl. CPC G06F 13/364
USPC 710/110

(57) ABSTRACT

An Inter-Integrated Circuit (I2C) bus structure includes a master device and a slave device. The slave device is connected to the master device via an I2C bus and an interrupt line. When the master device receives an interrupt request from the slave device via the interrupt line, the master device determines that the slave device is available. When the master device has not received any interrupt request from the slave device via the interrupt line for a time period, the master device determines that the slave device is not available. A device availability query method is also provided.

### REFERENCE TO RELATED APPLICATIONS

This application claims all benefits accruing under 35 U.S.C. §119 from China Patent Application No. 201210489544.X, filed on Nov. 27, 2012 in the State Intellectual Property Office of China. The contents of the China Application are hereby incorporated by reference. In addition, subject matter relevant to this application is disclosed in: co-pending U.S. Patent Application entitled “I2C BUS STRUCTURE AND ADDRESS MANAGEMENT METHOD,” Attorney Docket Number US47427, Application No. [to be advised], filed on the same day as the present application; and co-pending U.S. Patent Application entitled “I2C BUS STRUCTURE AND COMMAND TRANSMISSION METHOD,” Attorney Docket Number US47438, Application No. [to be advised], filed on the same day as the present application. This application and the two co-pending U.S. Patent Applications are commonly owned, and the contents of the two co-pending U.S. Patent Applications are hereby incorporated by reference

### BACKGROUND

1. Technical Field

The disclosure generally relates to bus structures, and particularly relates to Inter-Integrated Circuit (I2C) bus structure and device availability query methods for I2C bus structures.

2. Description of Related Art

For serial data communication between multiple devices, the Inter-Integrated Circuit (I2C) bus has been developed many years ago and has been widely accepted in the consumer electronics, telecommunications and industrial electronics fields. However, the greater the number of devices contained in an I2C bus structure, the greater the complexity of the I2C bus structure becomes and accordingly the I2C bus structure requires more hardware and software resources.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an exemplary embodiment of an I2C structure.

FIG. 2 is a flowchart showing an exemplary embodiment of a device availability query method.

FIG. 3 is a block diagram of another exemplary embodiment of an I2C structure.

FIG. 4 is a flowchart showing another exemplary embodiment of a device availability query method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

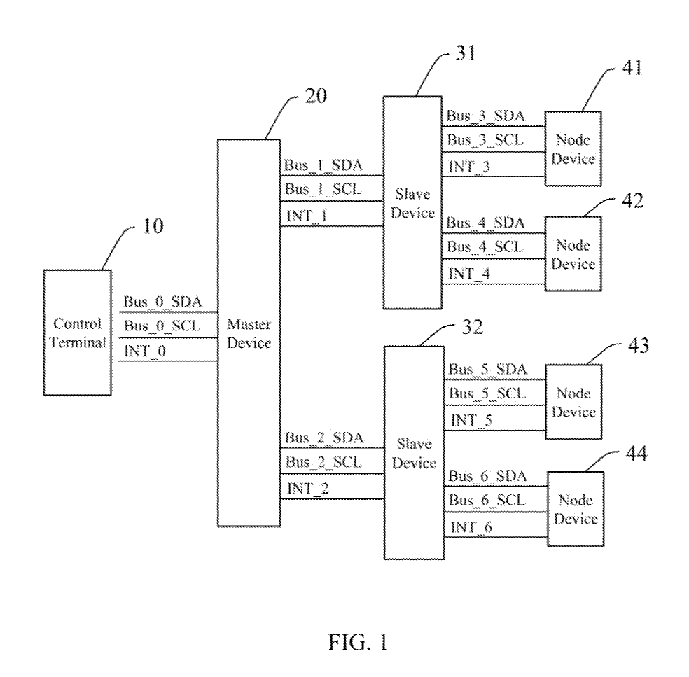

FIG. 1 shows an exemplary embodiment of an I2C structure. The I2C structure includes a control terminal 10, a master device 20, slave devices 31 and 32, and node devices 41, 42, 43, and 44. The number of slave devices and the node devices can be adjusted according to practical demands.

The control terminal 10 is connected to the master device 20 via an I2C bus Bus_0. The I2C bus Bus_0 includes a serial data line Bus_0_SDA and a serial clock line Bus_0_SCL. The control terminal 10 may transmit control commands to the master device 20 via the I2C bus Bus_0. The control terminal 10 may provide a user interface for receiving input from a user and for outputting information.

The master device 20 is connected to the slave device 31 via an I2C bus Bus_1 and to the slave device 32 via an I2C bus Bus_2. The I2C bus Bus_1 includes a serial data line Bus_1_SDA and a serial clock line Bus_1_SCL. The I2C bus Bus_2 includes a serial data line Bus_2_SDA and a serial clock line Bus_2_SCL. The master device 20 may receive control commands from the control terminal via the I2C bus Bus_0 and transmit the control commands to the slave device 31 via the I2C bus Bus_1 or the slave device 32 via the I2C bus Bus_2.

The slave device 31 is connected to the node device 41 via an I2C bus Bus_3 and to the node device 42 via an I2C bus Bus_4. The I2C bus Bus_3 includes a serial data line Bus_3_SDA and a serial clock line Bus_3_SCL. The I2C bus Bus_4 includes a serial data line Bus_4_SDA and a serial clock line Bus_4_SCL. The slave device 31 receives control commands from the master device 20 via the I2C bus Bus_1 and transmits the control commands to the node device 41 via the I2C bus Bus_3 or the node device 42 via the I2C bus Bus_4.

The slave device 32 is connected to the node device 42 via an I2C bus Bus_5 and to the node device 44 via an I2C bus Bus_6. The I2C bus Bus_5 includes a serial data line Bus_5_SDA and a serial clock line Bus_5_SCL. The I2C bus Bus_6 includes a serial data line Bus_6_SDA and a serial clock line Bus_6_SCL. The slave device 32 receives control commands from the master device 20 via the I2C bus Bus_2 and transmits the control commands to the node device 43 via the I2C bus Bus_5 or the node device 44 via the I2C bus Bus_6.

The node devices 41-44 are located in the lowest layer of the I2C structure. The node devices 41-42 receive control commands from the slave device 31 via the I2C buses Bus_3 and Bus_4 and perform corresponding actions in response to the received control commands. The node devices 43-44 receive control commands from the slave device 32 via the I2C buses Bus_5 and Bus_6 and perform corresponding actions in response to the received control commands

The master device 20 and the slave devices 31-32 may work in a hub mode or a switch mode. When the master device 20 and the slave devices 31-32 work in the hub mode, the master device 20 broadcasts control commands to each of the slave devices 31-32, the slave device 31 broadcasts control commands to each of the node devices 41-42, and the slave device 32 broadcasts control commands to each of the node devices 43-44. When the master device 20 and the slave devices 31-32 work in the switch mode, the master device 20 selectively transmits control commands to the slave devices 31-32, the slave device 31 selectively transmits control commands to the node devices 41-42, and the slave device 32 selectively transmits control commands to the node devices 43-44.

FIG. 1 shows that the I2C bus structure further includes interrupt lines INT_0, INT_1, INT_2, INT_3, INT_4, INT_5, and INT_6.

The interrupt line INT_0 interconnects the control terminal 10 and the master device 20. The master device 20 may send an interrupt request to the control terminal 10 via the interrupt line INT_0. When the control terminal 10 receives an interrupt request from the master device 20, the control terminal 10 determines that the master device 20 is available. When the control terminal 10 has not received any interrupt request from the master device 20 for a time period, the control terminal 10 determines that the master device 20 is not available for some reason, for example, being shut down, busy, or having failed. The control terminal 10 includes a register for storing the availability status of the master device 20.

The interrupt line INT_1 interconnects the master device 20 and the slave device 31. The interrupt line INT_2 interconnects the master device 20 and the slave device 32. The slave device 31 may send an interrupt request to the master device 20 via the interrupt line INT_1. The slave device 32 may send an interrupt request to the master device 20 via the interrupt line INT_2. When the control terminal 10 receives an interrupt request from the slave device 31, the control terminal 10 determines that the slave device 31 is available. When the control terminal 10 has not received any interrupt request from the slave device 31 for a time period, the control terminal 10 determines that the slave device 31 is not available for some reason, for example, being shut down, busy, or having failed. When the control terminal 10 receives an interrupt request from the slave device 32, the control terminal 10 determines that the slave device 32 is available. When the control terminal 10 has not received any interrupt request from the slave device 32 for a time period, the control terminal 10 determines that the slave device 32 is not available for some reason, for example, being shut down, busy, or having failed. The master device 20 includes registers for storing the availability statuses of the slave devices 31 and 32.

The interrupt line INT_3 interconnects the slave device 31 and the node device 41. The interrupt line INT_4 interconnects the slave device 31 and the node device 42. The node device 41 may send an interrupt request to the slave device 31 via the interrupt line INT_3. The node device 42 may send an interrupt request to the slave device 31 via the interrupt line INT_4. When the slave device 31 receives an interrupt request from the node device 41, the slave device 31 determines that the node device 41 is available. When the slave device 31 has not received any interrupt request from the node device 41 for a time period, the slave device 31 determines that the node device 41 is not available for some reason, for example, being shut down, busy, or having failed. When the slave device 31 receives an interrupt request from the node device 42, the slave device 31 determines that the node device 42 is available. When the slave device 31 has not received any interrupt request from the node device 42 for a time period, the slave device 31 determines that the node device 42 is not available for some reason, for example, being shut down, busy, or having failed. The slave device 31 includes registers for storing the availability statuses of the node devices 41 and 42.

The interrupt line INT_5 interconnects the slave device 32 and the node device 43. The interrupt line INT_6 interconnects the slave device 32 and the node device 44. The node device 43 may send an interrupt request to the slave device 32 via the interrupt line INT_5. The node device 44 may send an interrupt request to the slave device 32 via the interrupt line INT_6. When the slave device 32 receives an interrupt request from the node device 43, the slave device 32 determines that the node device 43 is available. When the slave device 32 has not received any interrupt request from the node device 43 for a time period, the slave device 32 determines that the node device 43 is not available for some reason, for example, being shut down, busy, or having failed. When the slave device 32 receives an interrupt request from the node device 44, the slave device 32 determines that the node device 44 is available. When the slave device 32 has not received any interrupt request from the node device 44 for a time period, the slave device 32 determines that the node device 44 is not available for some reason, for example, being shut down, busy, or having failed. The slave device 32 includes registers for storing the availability statuses of the node devices 43 and 44.

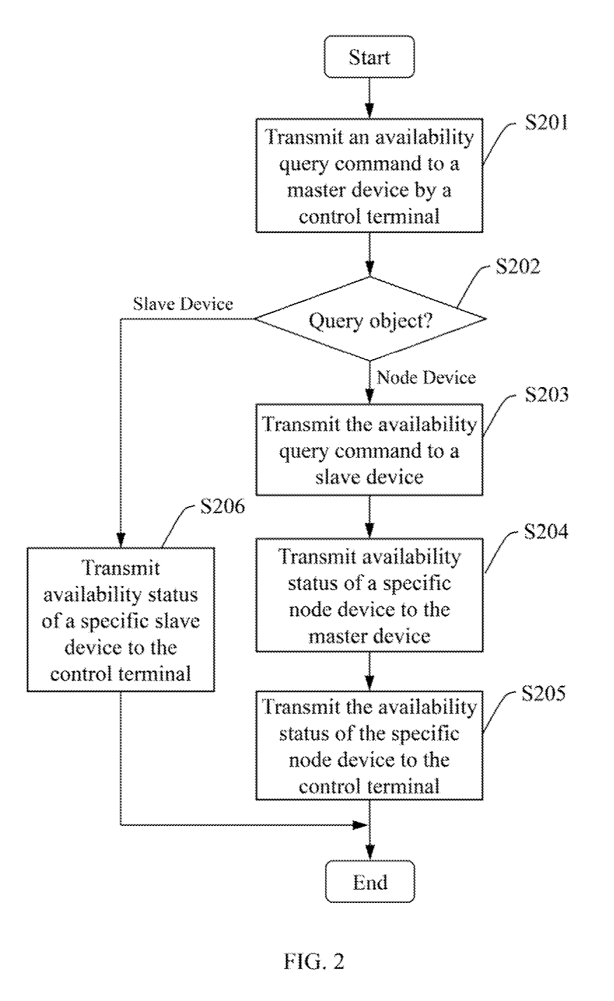

FIG. 2 is a flowchart showing an exemplary embodiment of a device availability query method. The method includes the following steps.

In step 201, the control terminal 10 transmits an availability query command to the master device 20. The availability query command is in associated with a query object. The query object may be a specific slave device, e.g., the slave device 31 or 32, or a specific node device, e.g., the node device 41, 42, 43, or 44.

In step 202, if the associated query object is a specific slave device, the flow proceeds to step S206. If the associated query object is a specific node device, the flow proceeds to step S203.

In step 203, the master device 20 transmits the availability query command to a slave device 31 or 32 to which the specific node device is connected.

In step 204, the slave device 31 or 32 obtains the availability status of the specific node device from its register and transmits the availability status of the specific node device to the master device 20.

In step 205, the master device 20 transmits the availability status of the specific mode device to the control terminal 10 via the I2C bus Bus_0.

In step 206, the master device 20 obtains the availability status of the specific slave device from its register and transmits the availability status of the specific slave device to the control terminal 10 via the I2C bus Bus_0.

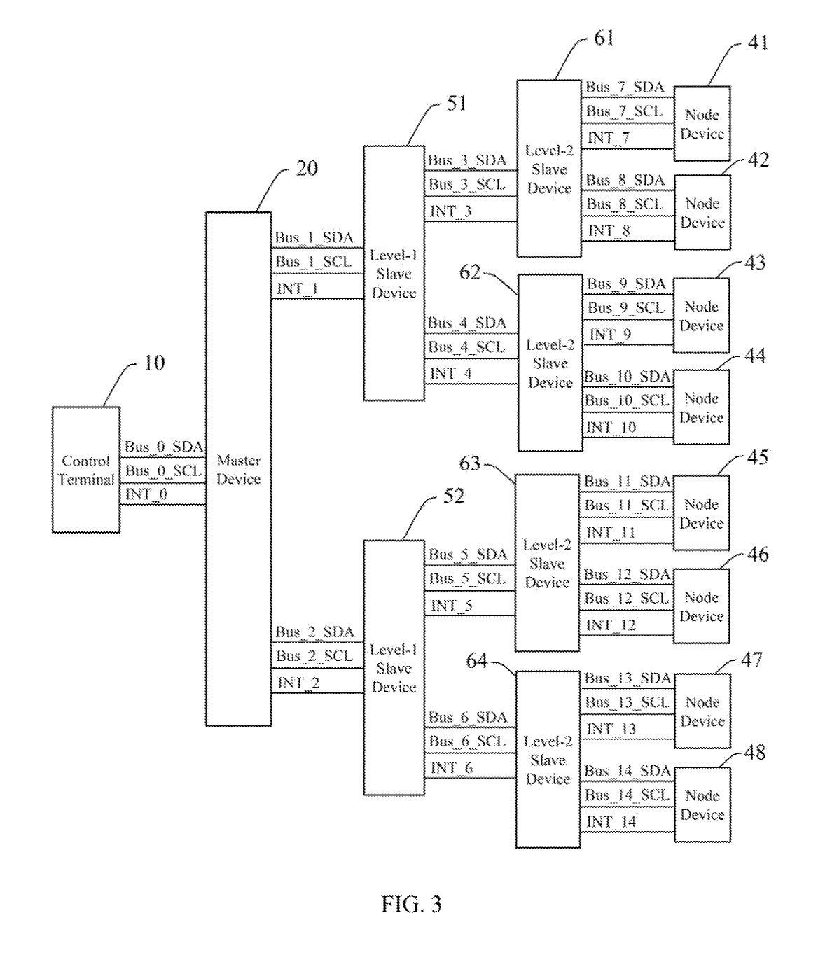

FIG. 3 shows another exemplary embodiment of an I2C structure. The I2C structure includes a control terminal 10, a master device 20, level-1 slave devices 51-52, level-2 slave devices 61-64, and node devices 41-48. The level-1 slave devices 51-52 and the level-2 slave devices 61-64 are similar to the slave devices 31-32 in the embodiment shown in FIG. 1. The master device 20 is connected to the level-1 slave device 51 via an I2C bus Bus_1 and an interrupt line INT_1, and to the level-1 slave device 52 via an I2C bus Bus_2 and an interrupt line INT_2. The level-1 slave device 51 is connected to the level-2 slave device 61 via an I2C bus Bus_3 and an interrupt line INT_3, and to the level-2 slave device 62 via an I2C bus Bus_4 and an interrupt line INT_4. The level-1 slave device 52 is connected to the level-2 slave device 63 via an I2C bus Bus_5 and an interrupt line INT_5, and to the level-2 slave device 64 via an I2C bus Bus_6 and an interrupt line INT_6. The node devices 41-48 are connected to the level-2 slave devices 61-64 via I2C buses Bus_7 to Bus_14 and interrupt lines INT_7 to INT_14.

The level-1 slave devices 51-52 may send interrupt requests to the master device 20 via the interrupt lines INT_1 and INT_2. The master device 20 may determine the availability statuses of the level-1 slave devices 51-52 based on whether the master device 20 receives any interrupt requests from the level-1 slave devices 51-52.

The level-2 slave devices 61-64 may send interrupt requests to the level-1 slave devices 51-52 via the interrupt lines INT_3 to INT_6. The level-1 slave devices 51-52 may determine the availability statuses of the level-2 slave devices 61-64 based on whether the level-1 slave devices 51-52 receive interrupt requests from the level-2 slave devices 61-64.

The node devices 41-48 may send interrupt requests to the level-2 slave devices 61-64 via the interrupt lines INT_7 to INT_14. The level-2 slave devices 61-64 may determine the availability statuses of the node devices 41-48 based on whether the level-2 slave devices 61-64 receive interrupt requests from the node devices 41-48.

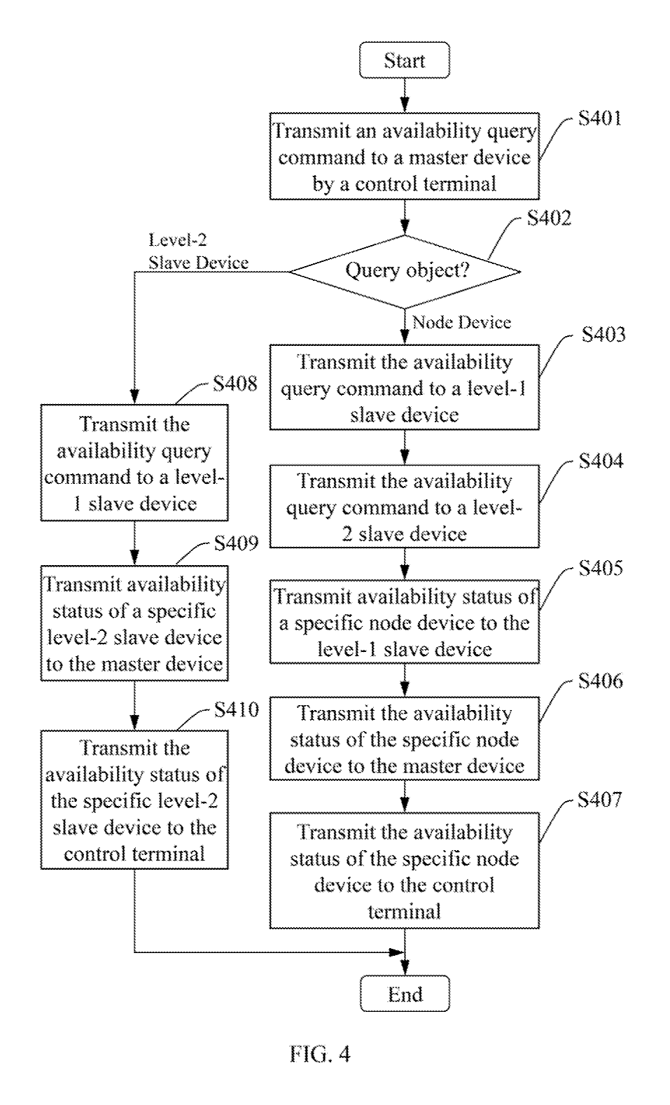

FIG. 4 is a flowchart showing another exemplary embodiment of a device availability query method. The method includes the following steps.

In step 401, the control terminal 10 transmits an availability query command to the master device 20. The availability query command is associated with a query object. The query object may be a specific level-2 slave device, e.g., the level -2 slave device 61, 62, 63, or 64, or a specific node device, e.g., the node device 41, 42, 43, 44, 45, 46, 47, or 48.

In step 402, if the query object is a specific level-2 slave device, the flow proceeds to step S408. If the query object is a specific node device, the flow proceeds to step S403.

In step 403, the master device 20 determines a path directed to the specific node device. The path includes a specific level-1 slave device and a specific level-2 slave device. The specific level-2 slave device is connected to the specific node device. The master device 20 transmits the availability query command to the specific level-1 slave device.

In step 404, the specific level-1 slave device transmits the availability query command to the specific level-2 slave device.

In step 405, the specific level-2 slave device obtains the availability status of the specific node device from its register and transmits the availability status of the specific node device to the specific level-1 slave device.

In step 406, the specific level-1 slave device transmits the availability status of the specific node device to the master device 20.

In step 407, the master device 20 transmits the availability status of the specific node device to the control terminal 10 via the I2C bus Bus_0.

In step 408, the master device 20 transmits the availability query command to a specific level-1 slave device to which the specific level-2 slave device is connected.

In step 409, the specific level-2 device obtains the availability status of the specific level-2 slave device from its register and transmits the availability status of the specific level-2 slave device to the master device 20.

In step 410, the master device 20 transmits the availability status of the specific level-2 slave device to the control terminal 10 via the I2C bus Bus_0.

The address setting pins A1 and A2 of the address setter 52 are connected to the address pins P1 and P0 of the slave device 32 via address lines A_3 and A_4. The address setter 50 may set the electrical levels of the address pins P1 and P0 of the slave device 32 via the address lines A_3 and A_4, thereby resetting the device address of the slave device 32.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An Inter-Integrated Circuit (I2C) bus structure, comprising:
a master device;
a slave device connected to the master device via a first I2C bus and an first interrupt line;
when the master device receives an interrupt request from the slave device via the first interrupt line, the master device is adapted to determine that the slave device is available, when the master device has not received any interrupt request from the slave device via the first interrupt line for a time period, the master device is adapted to determine that the slave device is not available.

2. The I2C bus structure of claim 1, further comprising a control terminal connected to the master device via a second I2C bus, wherein the control terminal is adapted to transmit an availability query command to the master device via the second I2C bus, if the availability query command is associated with the slave device, the master device is adapted to transmit availability status of the slave device to the control terminal via the second I2C bus in response to the availability query command

3. The I2C bus structure of claim 2, wherein the master device comprises a first register adapted to store the availability status of the slave device.

4. The I2C bus structure of claim 2, wherein the control terminal is further adapted to provide a user interface and receive control commands from a user through the user interface.

5. The I2C bus structure of claim 2, further comprising a plurality of node devices connected to the slave device via a plurality of third I2C buses, wherein the control terminal is adapted to transmit the control commands to the master device via the second I2C bus, the master device is adapted to transmit the control commands to the slave device via the first I2C bus, the slave device is adapted to transmit the control commands to the plurality of node devices via the plurality of third I2C buses.

6. The I2C bus structure of claim 5, further comprising a plurality of second interrupt lines, wherein each of the plurality of second interrupt lines interconnects one of the plurality of node devices and the slave device, when the slave device receives an interrupt request one of the plurality of node devices, the slave device is adapted to determine that the one of the plurality of node devices is available, when the slave device has not received any interrupt request from one of the plurality of node devices for a time period, the slave device is adapted to determine that the one of the plurality of node devices is not available.

7. The I2C bus structure of claim 6, wherein if the availability query command is associated with one of the plurality of node devices, the master device is adapted to transmit the availability query command to the slave device.

8. The I2C bus structure of claim 7, wherein the slave device is adapted to transmit availability status of the one of the plurality of node devices to the master device via the first I2C bus in response to the availability query command

9. The I2C bus structure of claim 8, wherein the slave device comprises a second register adapted to store availability statuses of the plurality of node devices.

10. The I2C bus structure of claim 5, wherein each of the first I2C bus, the second I2C bus, and the plurality of third I2C buses comprises a serial data line and a serial clock line.

11. A device availability query method, comprising:
connecting a master device to a slave device via a first I2C buss and a first interrupt line;
determining, by the master device, that the slave device is available when the master device receives an interrupt request from the slave device via the first interrupt line; and
determining, by the master device, that the slave device is not available when the master device has not received any interrupt request from the slave device via the first interrupt line for a time period.

12. The device availability query method of claim 11, further comprising:
connecting a control terminal to the master device via a second I2C bus;
transmit an availability query command to the master device via the second I2C bus by the control terminal; and
when the availability query command is associated with the slave device, transmitting, by the master device, availability status of the slave device to the control terminal via the second I2C bus in response to the availability query command

13. The device availability query method of claim 12, further comprising storing the availability status of the slave device in a first register of the master device.

14. The device availability query method of claim 12, further comprising providing, by the control terminal, a user interface and receiving control commands from a user through the user interface.

15. The device availability query method of claim 12, further comprising:
connecting a plurality of node devices to the slave device via a plurality of third I2C buses;
transmitting the control commands to the master device via the second I2C bus by the control terminal;
transmitting the control commands to the slave device via the first I2C bus by the master device; and
transmitting the control commands to the plurality of node devices via the plurality of third I2C buses by the slave device.

16. The device availability query method of claim 15, further comprising:
connecting each of the plurality of node devices to the slave device via a second interrupt line;
when the slave device receives an interrupt request one of the plurality of node devices, determining, by the slave device, that the one of the plurality of node devices is available; and
when the slave device has not received any interrupt request from one of the plurality of node devices for a time period, determining, by the slave device, that the one of the plurality of node devices is not available.

17. The device availability query method of claim 16, further comprising transmitting the availability query command to the slave device by the master device when the availability query command is associated with one of the plurality of node devices.

18. The device availability query method of claim 17, further comprising transmitting availability status of the one of the plurality of node devices to the master device via the first I2C bus by the slave device in response to the availability query command.

19. The device availability query method of claim 18, further comprising storing availability statuses of the plurality of node devices in a second register of the slave device.

20. The device availability query method of claim 15, wherein each of the first I2C bus, the second I2C bus, and the plurality of third I2C buses comprises a serial data line and a serial clock line.
